(19) United States
(12) Patent Application Publication
(10) Pub. No.: US 2011/0219221 A1
(43) Pub. Date: Sep. 8, 2011

(54) Dynamic warp subdivision for integrated branch and memory latency divergence tolerance

(76) Inventors: Kevin Skadron, Charlottesville, VA (US); Jiayuan Meng, Evanston, IL (US); David Tarjan, Santa Clara, CA (US)

(21) Appl. No.: 13/040,045

(22) Filed: Mar. 3, 2011

Related U.S. Application Data
(60) Provisional application No. 61/310,120, filed on Mar. 3, 2010.

(51) Int. Cl. G06F 9/38

(52) U.S. Cl. 712/235; 712/E09.045

(57) ABSTRACT

Dynamic warp subdivision (DWS), which allows a single warp to occupy more than one slot in the scheduler without requiring extra register file space, is described. Independent scheduling entities also allow divergent branch paths to interleave their execution, and allow threads that hit in the cache or otherwise have divergent memory-access latency to run ahead. The result is improved latency hiding and memory level parallelism (MLP).

### CROSS-REFERENCE TO RELATED APPLICATIONS

The present application claims the benefit of U.S. application No. 61/310,120 filed Mar. 3, 2010, which application is incorporated herein by reference for all purposes.

### BACKGROUND

One way to get computational results faster is to make a processor run faster. But sometimes, depending on the software being executed, there are ways to get computational results faster by optimizing the way in which the processor carries out the computations. The present invention directs itself to the latter approach for getting computational results faster.

To explain the present invention it is helpful to review some background and to establish a shared vocabulary.

Single instruction, multiple data (SIMD) organizations use a single instruction sequencer to control multiple datapaths. SIMD is generally more efficient than multiple instruction, multiple data (MIMD) in exploiting data parallelism, because it allows greater throughput within a given area and power budget by amortizing the cost of the instruction sequencing over multiple datapaths. This is important, both because data parallelism is common across a wide range of applications; and because data-parallel throughput is increasingly important for high performance as single-thread performance improvement slows.

SIMD can operate on multiple datapaths in the form of a vector. It can also operate in the form of an array with a set of scalar datapaths. The latter is referred to by NVIDIA as single instruction multiple threads (SIMT). For purpose of generality in this discussion, we will refer to the set of operations happening in lockstep as a warp and the application of an instruction sequence to a single lane as a thread. We refer to a set of hardware units under SIMD control as a warp processing unit or WPU. SIMD organizations of both types are increasingly common in architectures for high throughput computing, exemplified today in the Cell Broadband Engine (CBE, M. Gschwind, Chip multiprocessing and the Cell Broadband Engine, In CF, 2006), Clearspeed (Y. Nishikawa, M. Koibuchi, M. Yoshimi, K. Miura, and H. Amano. Performance improvement methodology for ClearSpeed's CSX600, in ICPP, 2007), and Larrabee (L. Seiler, D. Carmean, E. Sprangle, T. Forsyth, M. Abrash, P. Dubey, S. Junkins, A. Lake, J. Sugerman, R. Cavin, R. Espasa, E. Grochowski, T. Juan, and P. Hanrahan, Larrabee: a many-core x86 architecture for visual computing, ACM Trans. Graph., 27(3), 2008). Graphics processors (GPUs), including NVIDIA's Tesla (NVIDIA Corporation, GeForce GTX 280 specifications, 2008), Fermi (NVIDIAs next generation CUDA compute architecture: Fermi, NVIDIA Corporation, 2009), and ATI's recent architectures (ATI, Radeon 9700 Pro, 2002), also employ SIMD organizations and are increasingly used for general-purpose computing. Academic researchers have also proposed stream architectures that employ SIMD organizations. For both productivity and performance purposes, an increasing number of SIMD organizations support gather loads (i.e. load a vector from a vector of arbitrary addresses) or scatter stores (i.e. store a vector to a vector of arbitrary addresses) using cache hierarchies. This introduces the possibility of divergent memory access latency, because a SIMD gather or scatter may access a set of data that is not fully in the cache.

Like other throughput-oriented organizations that try to maximize thread concurrency and hence do not waste area on instruction level parallelism discovery, WPUs employ in-order pipelines that have limited ability to execute past L1 cache misses or other long latency events. To hide memory latencies, the WPU can time-multiplex among multiple concurrent warps, each with its own PCs and registers.

In the systems just described, the multi-threading depth (i.e. number of warps) is limited, however, because adding more warps multiplies the area overhead in register files, and it may increase cache contention as well. As a result, the WPU may run out of work. This can occur even when there are runnable threads that are stalled only due to SIMD lockstep restrictions.

Single-instruction/multiple-data or “SIMD” organizations share one instruction fetch/decode/issue unit (or “front end”) across multiple processing units in order to maximize throughput for a given area and power budget when parallel tasks exhibit similar execution sequences. We refer to the set of processors sharing a front end as a warp processing unit (WPU). All threads executing at a given point in time on a WPU operate in lockstep. We refer to the threads operating in lockstep as a warp. Throughput is reduced, however, when warps are stalled due to long latency memory accesses. The resulting idle cycles are extremely costly. Multi-threading can hide latencies by interleaving the execution of multiple warps, but deep multi-threading using many warps dramatically increases the cost of the register files (multi-threading depth vs. SIMD width), and cache contention can make performance worse. Instead, intra-warp latency hiding should first be exploited. This allows threads that are ready but stalled by SIMD restrictions to use these idle cycles and reduces the need for multi-threading.

### SUMMARY OF THE INVENTION

The invention introduces dynamic warp subdivision (DWS), which allows a single warp to occupy more than one slot in the scheduler without requiring extra register file space. Independent scheduling entities also allow divergent branch paths to interleave their execution, and allow threads that hit to run ahead. The result is improved latency hiding and memory level parallelism (MLP). The inventors evaluated the technique on a coherent cache hierarchy with private L1 caches and a shared L2 cache. With an area overhead of less than 1%, experiments with eight data-parallel benchmarks show the inventive technique to improve performance on average by 1.60×, outperforming previous proposed techniques by a factor of 30%.

### DESCRIPTION OF THE DRAWING

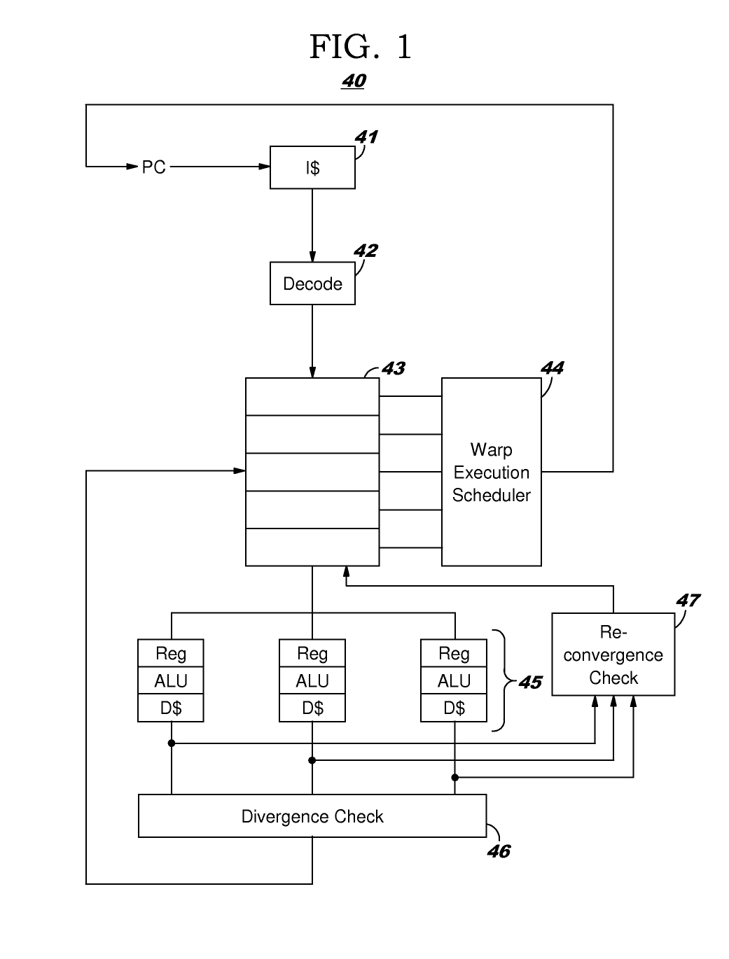

The invention will be described with respect to a drawing FIGURE, namely FIG. 1 which shows a computational organization exemplary of the invention.

### DETAILED DESCRIPTION OF THE INVENTION

In an exemplary system, two thread categories are handled in a way that achieves intra-warp latency hiding when the WPU has insufficient runnable warps.

One category relates to threads that are suspended due to branch divergence. Branch divergence occurs when threads in the same warp take different paths upon a conditional branch. A typical way in which this happens is that the code being executed reaches an “if” statement. When a branch happens, the WPU can only execute one path of the branch at a time for a given warp, with some threads masked off if they took the branch in the alternate direction. In array organizations, this is handled in hardware by a re-convergence stack; in vector organizations, this is handled in software by using the branch outcomes as a set of predicates. In either case, allowing both paths to run creates problems in re-converging the warp.

A second category relates to threads that are suspended due to memory latency divergence. Memory latency divergence occurs when threads from a single warp experience non-identical memory-reference latencies caused (for example) by cache misses or by accessing different DRAM banks. When a memory divergence happens, the entire warp must wait until the last thread has its reference satisfied. Only after that is the warp able to move forward again. Memory latency divergence can occur not only in array organizations, but also in vector organizations if the vector instruction set allows gather or scatter operations.

In keeping with the invention, an approach called “dynamic warp subdivision” (DWS) is employed to utilize both of the thread categories just mentioned. In the inventive system, warps are selectively subdivided into warp-splits. Each warp split has fewer threads than the available SIMD width, but can be individually regarded as an additional scheduling entity to hide latency. This is carried out as follows.
1. Upon branch divergence, a warp can be divided into two active warp-splits, each representing threads that fall into one of the branch paths. The WPU can then interleave the computation of different branch paths to hide memory latency.
2. Upon memory latency divergence, a warp can be divided into two warp-splits, one split represents threads that did hit the cache, the other split representing threads that missed the cache. It will be appreciated that the former warp-split need not suspend, because it can run ahead non-speculatively. Its activity may in fact help the latter warp-split to move ahead because it may happen to prefetch cache lines that may be needed later by one or more threads in the latter warp-split.

The warp splitting prompted by memory latency divergence can be thought of as dividing the warp into a run-ahead warp split (the split representing threads that did hit the cache) and a fall-behind warp split (the split representing threads that ran into cache misses.

The approach of the invention does not necessarily stop with a single warp split. In a general case it is to be expected that for example a warp might get split into first and second warp splits due to memory latency divergence, and then one of those splits might in turn get split into smaller splits due to branch divergence. Or as another example a warp might get split into first and second warp splits due to branch divergence, and then one of those splits might in turn get split into smaller splits due to memory latency divergence. Still another example could be a warp that gets split into first and second warp splits due to memory latency divergence, and then one of those splits might in turn get split into smaller splits due to yet another (subsequent) memory latency divergence. And another example could be a warp that gets split into first and second warp splits due to branch divergence, and then one of those splits might in turn get split into smaller splits due to yet another (subsequent) branch divergence.

The general theme in this part of the discussion is that the splitting of warps can be recursive, leading to a split of a previous warp split, and then a split of one of those warp splits, and so on. In a rather fluid way, the warps could get split, and then recombined, and split again, and recombined, each split triggered by some particular divergence event, each recombination being triggered by some re-convergence condition being satisfied. The manner of managing the split warps (namely adding an entry in the warp scheduler queue, and modifying another entry in that queue, so as to keep track of which threads are in which warp splits) and the manner of managing the recombinations (identifying two particular entries that had come about due to a particular split, and combining their threads into a single entry (and deleting the remaining entry), permits a very efficient management of the splitting and recombination, reducing to an absolute minimum the number of items that must get moved back and forth to bring about the splits and the recombinations. Once again, as mentioned above, one of the strengths of this approach (managing splits and recombinations by means of manipulations of scheduler queue entries) is that it is equally suited to managing splits prompted by memory latency divergences or splits prompted by branch divergences. Not only is it equally suited to both types of splits, but it readily handles recursion, by which is meant the ability to split up a split of a warp, and perhaps a split of that split, and so on.

To say the same thing in different words, warp can be split into multiple warp-splits due to any sequence of branch and memory-latency divergences.

When a warp split is carried out (whether due to branch divergence or due to memory latency divergence), stall cycles are reduced, latency hiding is improved, and the ability to overlap more outgoing memory requests leverages memory level parallelism (MLP). Of course, it would be undesirable if such splitting of warps were to reduce overall throughput rather than increasing overall throughput. Aggressive subdivision (too aggressively splitting warps) may result in performance degradation because it may lead to a large number of narrow warp-splits that only exploit a fraction of the SIMD computation resources. A dynamic mechanism is needed because the divergence pattern depends on run-time dynamics such as cache misses and it may vary across applications, phases of execution, and even different inputs.

We have evaluated several strategies for dynamic warp subdivision based upon eight distinct data-parallel benchmarks. Experiments are conducted by simulating WPUs operating over a two-level cache hierarchy that has private L1 caches sharing an inclusive, on-chip L2 (representative of many of today's SIMD organizations, including Intel's Larrabee and NVIDIA's Fermi). The results show that DWS improves the average performance across a diverse set of parallel benchmarks by 1.60×. It is robust and shows no performance degradation in any case. It is estimated that dynamic warp subdivision adds less than 1% area overhead to a WPU.

Existing products stall some threads in the presence of branch or memory latency divergence. In contrast, with an area overhead of less than 1%, experiments with eight data-parallel benchmarks show a technique of an embodiment of the present invention improves performance on average by 1.60×, outperforming previous proposed techniques by a factor of 30%.

FIG. 1 shows an exemplary SIMD organization 40 that is able to carry out the warp-splitting approach of the invention. An instruction cache 41 contains an instruction fetched with respect to a program counter (PC). The instruction is decoded at 42 and reaches a Warp Scheduler Queue 43. The Warp Scheduler Queue maintains a state for each warp or warp split. A Warp Execution Scheduler 44 draws upon the contents of the queue as will be discussed in more detail below.

FIG. 1 also shows several computational lanes (also called “processing elements”) 45, each of which has registers, an arithmetic logic unit, and a local data cache. From time to time each lane has a thread allocated to it from a warp.

A divergence check 46 takes place, identifying situations where it may be desired to split a warp. One situation (as mentioned above) is the event of a cache miss. Another situation (also mentioned above) is a branch (for example an “if” statement). In the event of a divergence, it may be decided to split a warp. There is more than one way that a warp could be split (in terms of the steps carried out to achieve the split) but what is considered preferable is to avoid the need to move large amounts of data from one place to another within the organization. Such movements of data are costly in terms of processing bandwidth. The approach thought to be preferable is that the organization simply creates a new scheduler entry in the scheduler queue indicative of the threads allocated to one warp split and modifies an existing scheduler entry in the scheduler queue indicative of the remaining threads in the other warp split.

From time to time a re-convergence check 47 takes place, which is preferably carried out through two mechanisms. One mechanism is to periodically check the PC for each warp split to see whether any two splits have resynchronized. Another mechanism is the use of post-dominators, which signal when diverged warp-splits can be re-converged, for example warp-splits that happened because of a branch. If either mechanism indicates that a re-convergence is possible, then the re-convergence is achieved by updates to entries in the warp scheduler queue 43.

As a general matter, it is thought to be desirable to have both the divergence check process and the re-convergence check process running more or less in parallel. In this way, an event that prompts splitting a warp can be acted upon when it arises or very soon after it arises, and an event that prompts restoring two split warps into the warp whence they were created can likewise be acted upon when it arises or very soon after it arises.

It will be helpful to say a little more about re-convergence. First, re-convergence is essential. Assuming that the purpose of the system is to achieve computational results, then, like parentheses in a mathematical expression which always appear in pairs, for each split of a warp into two split warps, there must necessarily eventually be a recombination of the two split warps back into a warp that carries on the work of the warp whence the split warps came. Eventually the execution of the software is complete, and (if all goes well) it will present the same outcome as if no splits at all had occurred, only faster than if no splitting had happened. With this in mind, we comment on re-convergence.

One of the triggers for recombining splits, as mentioned above, is the event of the PCs once again matching, for example, that the fall-behind split has finally caught up with the run-ahead split. This raises the question of when and how often to compare PCs. On the one hand it would be desirable to compare PCs very frequently so as to figure it out right away (without delay) if two splits are now able to be recombined, so as to minimize how long the split condition persists. On the other hand one would not wish to incur needless overhead with PC comparisons carried out at particular times when such comparison is futile, that is, particular times when it would not anyway be possible to recombine.

One approach is to compare PCs every clock cycle. PCs need to be compared every clock cycle only if the scheduler preemptively changes the active warp every cycle; that is, the scheduler will switch warp-splits arbitrarily, even if the running warp-split does not encounter any memory access, synchronization instructions, post-dominators or other specified conditions that can initiate a change in the active warp.

Another approach is to compare PCs only at designated scheduling points, such as memory access, explicit synchronization, or post-dominators. (To be more specific, we would typically be looking for cases where one warp stalls before making a scheduling decision.) In fact, unless the active warp changes preemptively, these designated conditions are the only possible places where a running warp-split can merge with a suspended warp-split, given a non-preemptive scheduler.

It is thought that some current commercial processors do preemptively change the active warp every cycle. In a system where the processor does preemptively change the active warp every cycle, then one would follow the first approach.

It should be appreciated that while the approach of the invention is described with respect to a particular management technique (inserting and deleting entries in a warp scheduler queue), the invention is not so limited to that particular embodiment. Other management techniques could be employed without departing, for example, from the general notion of dynamically performed warp splits and later recombinations.

Those skilled in the art will have no difficulty whatsoever devising myriad obvious variants and improvements upon the invention as described herein, all of which are intended to be encompassed within the claims which follow.

1. A method for use in a warp processing system, the warp processing system employing dynamic warps, each warp comprising a plurality of respective threads spawned as a consequence of a single instruction fetch, the method comprising the steps of:
spawning a warp;
responding to a first branch divergence having first and second branch paths by dividing the warp into first and second active warp-splits, the first warp-split representing respective threads that fall into the first branch path, the second warp-split representing respective threads that fall into the second branch path; and
interleaving computation of the first and second branch paths.

2. The method of claim 1 further comprising the steps of:
responding to a memory latency divergence defined by the event of at least one cache miss by at least one of the respective threads of one of the first and second active warp-splits, by dividing the one of the first and second active warp-splits into third and fourth active warp-splits, the third warp-split representing respective threads that hit the cache, the fourth warp-split representing one or more respective threads that missed the cache; and
continuing computation of the third warp-split.

3. The method of claim 1 further comprising the steps of:
responding to a second branch divergence having third and fourth branch paths by dividing the one of the first and second active warp-splits into third and fourth active warp-splits, the third warp-split representing respective threads that fall into the third branch path, the fourth warp-split representing one or more respective threads that fall into the fourth branch path; and
interleaving computation of the third and fourth branch paths.

4. The method of claim 1 wherein the dividing of a warp into first and second active warp-splits is accomplished by adding an entry to a warp scheduler queue, the entry indicative of particular threads associated with one of the first and second active warp-splits, and modifying an existing entry in the warp scheduler queue so as to be indicative of particular threads associated with another of the first and second active warp-splits.

5. The method of claim 1 wherein the dividing of a warp into first and second active warp-splits hides at least some memory latency.

6. The method of claim 1 further comprising the step of detecting a condition permitting recombination of the first and second active warp-splits, and in response thereto, recombining the first and second active warp-splits.

7. A method for use in a warp processing system, the warp processing system employing dynamic warps, each warp comprising a plurality of respective threads spawned as a consequence of a single instruction fetch, the system having a cache, memory references to the cache variously defining cache hits and cache misses, the method comprising the steps of:
spawning a warp;
responding to a first memory latency divergence defined by the event of at least one cache miss by at least one of the respective threads of the warp by dividing the warp into first and second active warp-splits, the first warp-split representing respective threads that hit the cache, the second warp-split representing one or more respective threads that missed the cache; and
continuing computation of at least the first warp-split.

8. The method of claim 7 further comprising the steps of:
responding to a second memory latency divergence defined by the event of at least one cache miss by at least one of the respective threads of the one of the first and second active warp-splits, by dividing the one of the first and second active warp-splits into third and fourth active warp-splits, the third warp-split representing respective threads that hit the cache, the fourth warp-split representing one or more respective threads that missed the cache; and
continuing computation of at least the third warp-split.

9. The method of claim 7 further comprising the steps of:
responding to a branch divergence having third and fourth branch paths by dividing the one of the first and second active warp-splits into third and fourth active warp-splits, the third warp-split representing respective threads that fall into the third branch path, the fourth warp-split representing one or more respective threads that fall into the fourth branch path; and
interleaving computation of the third and fourth branch paths.

10. The method of claim 7 wherein the dividing of a warp into first and second active warp-splits is accomplished by adding an entry to a warp scheduler queue, the entry indicative of particular threads associated with one of the first and second active warp-splits, and modifying an existing entry in the warp scheduler queue so as to be indicative of particular threads associated with another of the first and second active warp-splits.

11. The method of claim 7 wherein the dividing of a warp into first and second active warp-splits hides at least some memory latency.

12. The method of claim 7 further comprising the step of detecting a condition permitting recombination of the first and second active warp-splits, and in response thereto, recombining the first and second active warp-splits.

13. The method of claim 7 wherein the step of detecting a condition permitting recombination of the first and second active warp-splits comprises comparing the program counter (PC) for each of the warp-splits, the condition comprising the PC being the same for each of the warp-splits.

14. The method of claim 13 wherein the comparison of the PC is carried out once for each processor clock cycle.

15. A single instruction, multiple data organization system disposed to employ dynamic warps, each warp comprising a plurality of respective threads spawned as a consequence of a single instruction fetch, the system comprising:
means responsive to a first branch divergence having first and second branch paths for dividing a warp into first and second active warp-splits, the first warp-split representing respective threads that fall into the first branch path, the second warp-split representing respective threads that fall into the second branch path; and
means interleaving computation of the first and second branch paths.

16. The system of claim 15 further comprising:
means responsive to a memory latency divergence defined by the event of at least one cache miss by at least one of the respective threads of the one of the first and second active warp-splits, for dividing the one of the first and second active warp-splits into third and fourth active warp-splits, the third warp-split representing respective threads that hit the cache, the fourth warp-split representing one or more respective threads that missed the cache; and
means continuing computation of the third warp-split.

17. The system of claim 15 further comprising:
means responding to a second branch divergence having third and fourth branch paths for dividing the one of the first and second active warp-splits into third and fourth active warp-splits, the third warp-split representing respective threads that fall into the third branch path, the fourth warp-split representing one or more respective threads that fall into the fourth branch path.

18. The system of claim 15 wherein dividing means divides a warp into first and second active warp-splits by adding an entry to a warp scheduler queue, the entry indicative of particular threads associated with one of the first and second active warp-splits, and modifying an existing entry in the warp scheduler queue so as to be indicative of particular threads associated with another of the first and second active warp-splits.

19. The system of claim 15 wherein the system further comprises means responsive to detection of a condition permitting recombination of the first and second active warp-splits for recombining the first and second active warp-splits.

20. A single instruction, multiple data organization system disposed to employ dynamic warps, each warp comprising a plurality of respective threads spawned as a consequence of a single instruction fetch, the system comprising:
means responsive to a first memory latency divergence defined by the event of at least one cache miss by at least one of the respective threads of a warp for dividing the warp into first and second active warp-splits, the first warp-split representing respective threads that hit the cache, the second warp-split representing one or more respective threads that missed the cache; and
means continuing computation of the first warp-split.

21. The system of claim 20 further comprising:
means responsive to a second memory latency divergence defined by the event of at least one cache miss by at least one of the respective threads of the one of the first and second active warp-splits, for dividing the one of the first and second active warp-splits into third and fourth active warp-splits, the third warp-split representing respective threads that hit the cache, the fourth warp-split representing one or more respective threads that missed the cache.

22. The system of claim 20 further comprising:
means responsive to a branch divergence having third and fourth branch paths for dividing the one of the first and second active warp-splits into third and fourth active warp-splits, the third warp-split representing respective threads that fall into the third branch path, the fourth warp-split representing one or more respective threads that fall into the fourth branch path; and
means interleaving computation of the third and fourth branch paths.

23. The system of claim 20 wherein the dividing of a warp into first and second active warp-splits is accomplished by adding an entry to a warp scheduler queue, the entry indicative of particular threads associated with one of the first and second active warp-splits, and modifying an existing entry in the warp scheduler queue so as to be indicative of particular threads associated with another of the first and second active warp-splits.

24. The system of claim 23 wherein is provided means responsive to detection of a condition permitting recombination of the first and second active warp-splits, for recombining the first and second active warp-splits.
